(19) United States
(12) Patent Application Publication
(10) Pub. No.: US 2016/0014781 A1
(43) Pub. Date: Jan. 14, 2016

(54) RADIO BASE STATION, USER TERMINAL AND RADIO COMMUNICATION METHOD

(71) Applicant: NTT DOCOMO, INC., Chiyoda-ku, Tokyo (JP)

(72) Inventors: Satoshi Nagata, Tokyo (JP); Yoshihisa Kishiyama, Tokyo (JP); Kazuaki Takeda, Tokyo (JP); Hiroyuki Ishii, Palo Alto, CA (US)

(73) Assignee: NTT DOCOMO, INC., Tokyo (JP)

(21) Appl. No.: 14/766,624

(22) PCT Filed: Jan. 30, 2014
(86) PCT No.: PCT/JP2014/052035

§ 371 Date: Aug. 7, 2015

(30) Foreign Application Priority Data
Feb. 13, 2013 (JP) 2013-025577

(51) Int. Cl. H04W 72/04

(52) U.S. Cl. CPC H04W 72/0453; H04W 72/082

(57) ABSTRACT

In a communication environment where a plurality of operators coexist, in order to minimize interference between the operators and also improve use efficiency of radio resources, a radio base station is disclosed. The radio base station includes an allocation control section that controls allocation to make an UL carrier for uplink transmission and a DL carrier for downlink transmission orthogonal to each other in a frequency direction, and a transmission/reception section that performs transmission or reception of a signal by using either of the UL carrier and the DL carrier for a user terminal in one transmission time interval. The allocation control section controls a carrier adjacent to a carrier used by a different operator to have same transmission direction as the carrier of the different carrier.

### TECHNICAL FIELD

The present invention relates to a radio base station, a user terminal and a radio communication method applicable to cellar systems or the like.

### BACKGROUND ART

In a UMTS (Universal Mobile Telecommunications System) network, for the purposes of improving spectral efficiency and improving data rates, system features based on W-CDMA (Wideband Code Division Multiple Access) are maximized by adopting HSDPA (High Speed Downlink Packet Access) and HSUPA (High Speed Uplink Packet Access). For this UMTS network, for the purposes of further increasing data rates, providing low delay and so on, long-term evolution (LTE) has been studied and standardized (see Non Patent Literature 1).

In a third-generation system, it is possible to achieve a transmission rate of maximum approximately 2 Mbps on the downlink by using a fixed band of approximately 5 MHz. In an LTE system, it is possible to achieve a transmission rate of about maximum 300 Mbps on the downlink and about 75 Mbps on the uplink by using a variable band which ranges from 1.4 MHz to 20 MHz. In the UMTS network, successor systems to LTE have been also studied and standardized for the purposes of achieving further broadbandization and higher speed (for example, which may be called LTE advanced or LTE enhancement (LTE-A)).

As duplex schemes in a radio communication, there are frequency division duplex (FDD) such that uplink (UL) and downlink (DL) are divided by frequency and time division duplex (TDD) in which uplink and downlink are divided by time. For TDD, the same frequency region is applied to uplink and downlink communications and signal transmission and reception is performed at one transmission/reception point by using different time regions between uplink and downlink.

In TDD of the LTE system, there are defined a plurality of frame configurations (DL/UP configurations) of which transmission rates are different between uplink subframes and downlink subframes (see FIG. 1). In the LTE system, as illustrated in FIG. 1, seven frame structures, DL/UL configurations 0 to 6, are defined and subframes #0 and #5 are assigned to downlink and subframe #2 is assigned to uplink. Generally speaking, in one certain frequency carrier, the same DL/UL configuration is applied to geographically adjacent transmission points in order to avoid interference between the transmission points (or cells). Or, in two adjacent frequency carriers, the same DL/UL configuration is applied to collocated transmission points or geographically adjacent transmission points in order to avoid interference between the transmission points (or cells).

There is another duplex scheme, Half Duplex FDD. The Half Duplex FDD scheme is such that different frequency regions (carriers or resource blocks (RBs)) are allocated to uplink and downlink, like in the FDD scheme, but, uplink transmission and downlink transmission are not performed simultaneously for a certain user terminal. In other words, uplink transmission and downlink transmission for a certain user terminal are divided by time. This time division of uplink transmission and downlink transmission is the same as that of the TDD scheme.

Since for one user terminal (1 UE), data allocation to radio resources is not performed simultaneously on uplink and downlink, uplink and downlink can be divided not only by frequency but also by time. In the case of the Half Duplex FDD scheme, as uplink and downlink signals can be separated easily, there is produced an advantageous effect of being able to simplify the configuration of the user terminal. That is, in order to implement the Full Duplex FDD scheme, it is necessary to provide a user terminal with a duplexer so as to prevent uplink transmission signals from causing interference to a receiver for downlink in the user terminal. On the other hand, in the Half Duplex FDD scheme, such a duplexer is not required to be provided thereby enabling simplification of the configuration of the user terminal.

### CITATION LIST

### Non-Patent Literature

Non-Patent Literature 1: 3GPP, TR 25.912 (V7.1.0), “Feasibility study for Evolved UTRA and UTRAN”, September 2006

### SUMMARY OF INVENTION

### Technical Problem

Generally, DL traffic and UL traffic are asymmetrical. In addition, the rates of DL traffic and UL traffic are not constant and vary with time or location. For example, considering the TDD case, it is preferable for effective use of radio resources that the DL/UL configuration as illustrated in FIG. 1 is not fixed but varies with time or location, in accordance with actual traffic movement.

More specifically, in TDD of LTE-A or later systems, in order to achieve effective use of radio resources, it has been considered that DL and UL transmission rates are changed dynamically in the time domain per transmission/reception point (Dynamic TDD). In this case, in the same time/frequency domain, if transmission of UL and DL subframes is performed simultaneously in geographically adjacent transmission/reception points, there occurs interference between the transmission/reception points or between user terminals, which may cause deterioration in communication quality. Or, in adjacent frequency regions, if transmission of DL and UL subframes is performed simultaneously in a plurality of transmission/reception points, there occurs interference between the transmission/reception points or user terminals, which may cause deterioration in communication quality.

Particularly, when a carrier of each operator (telecommunication company) is allocated adjacent to a carrier of another operator, there is sometimes a situation that transmissions of DL and UL subframes are performed simultaneously in the adjacent carriers of the different operators. Consequently, there occurs interference between the carriers used by the respective operators (particularly, between adjacent carriers) and the communication quality may be deteriorated.

In general, as adjacent different operators are business competitors, it is extremely difficult to handle such interference. For example, assume that in order to achieve effective use of radio resources of its own system, a certain operator changes the DL/UL transmission rates dynamically in the time domain as described above. This, at the same time, causes deterioration of the communication quality of an adjacent operator. Therefore, the change in transmission rate is impermissible for the adjacent operator. In other words, considering the interference between carriers that are adjacent in frequency, it is impossible to change the DL/UL transmission rates in the time domain dynamically in order to achieve effective use of radio resources, as mentioned above.

In addition, in order to reduce interference, it may be considered to provide a great gap between different operators, which, however, causes a problem of reduction in use efficiency of radio resources.

The present invention was carried out in view of the foregoing, and aims to provide a radio base station, a user terminal and a radio communication method that are capable of, in a communication environment where a plurality of operators exists, minimizing influence of interference between the operators and achieving effective use of radio resources.

### Solution to Problem

The present invention provides a radio base station comprising: an allocation control section that controls allocation to make an UL carrier for uplink transmission and a DL carrier for downlink transmission orthogonal to each other in a frequency direction; and a transmission/reception section that performs transmission or reception of a signal by using either of the UL carrier and the DL carrier for each user terminal in one transmission time interval, wherein the allocation control section controls a carrier adjacent to a carrier used by a different operator to have same transmission direction as the carrier of the different carrier.

### Advantageous Effects of Invention

According to the present invention, in a communication environment where a plurality of operators are located, it is possible to minimize influence of interference between the operators and improve use efficiency of radio resources.

### BRIEF DESCRIPTION OF DRAWINGS

FIG. 1 is a diagram for explaining an example of DL/UL configuration in TDD;

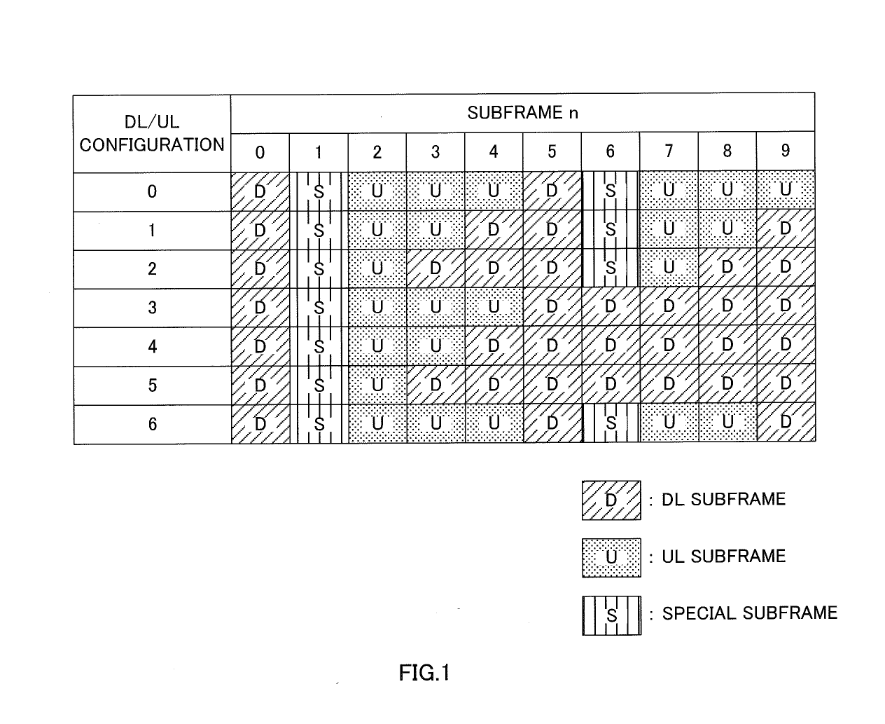

FIG. 2 provides diagrams illustrating an example of radio communication system adopting different DL/UL configurations between adjacent radio base stations;

FIG. 3 is a diagram illustrating an example of interference reduction method in dynamic TDD;

FIG. 4 is a diagram illustrating another example of interference reduction method in dynamic TDD;

FIG. 5 is a diagram illustrating an example of radio communication system in which radio base stations of different operators use the Half Duplex FDD mechanism;

FIG. 6 is a diagram illustrating an example of allocation method of UL and DL carriers in the first embodiment;

FIG. 7 provides diagrams each illustrating an example of change of the resource allocation rates of UL and DL carriers in the frequency domain;

FIG. 8 is a diagram for explaining a gap provided between adjacent carriers;

FIG. 9 is a diagram illustrating another example of allocation method of UL and DL carriers according to the first embodiment;

FIG. 10 is a diagram illustrating an example of allocation method of UL and DL carriers according to a second embodiment;

FIG. 11 provides diagrams each illustrating an example of allocation method of UL and DL carriers according to a third embodiment;

FIG. 12 is a sequence diagram illustrating an example of transmission timing of UL and DL carrier allocation information;

FIG. 13 provides diagrams each illustrating an example of the method for allocating cell-specific signals and channels in a radio base station that operates as a standalone type;

FIG. 14 is a diagram illustrating an example of the radio communication system;

FIG. 15 is a diagram for explaining the overall configuration of the radio base station;

FIG. 16 is a functional block diagram of a baseband signal processing section in the radio base station;

FIG. 17 is a diagram for explaining the overall configuration of a user terminal; and

FIG. 18 is a functional block diagram corresponding to a baseband signal processing section of the user terminal.

### DESCRIPTION OF EMBODIMENTS

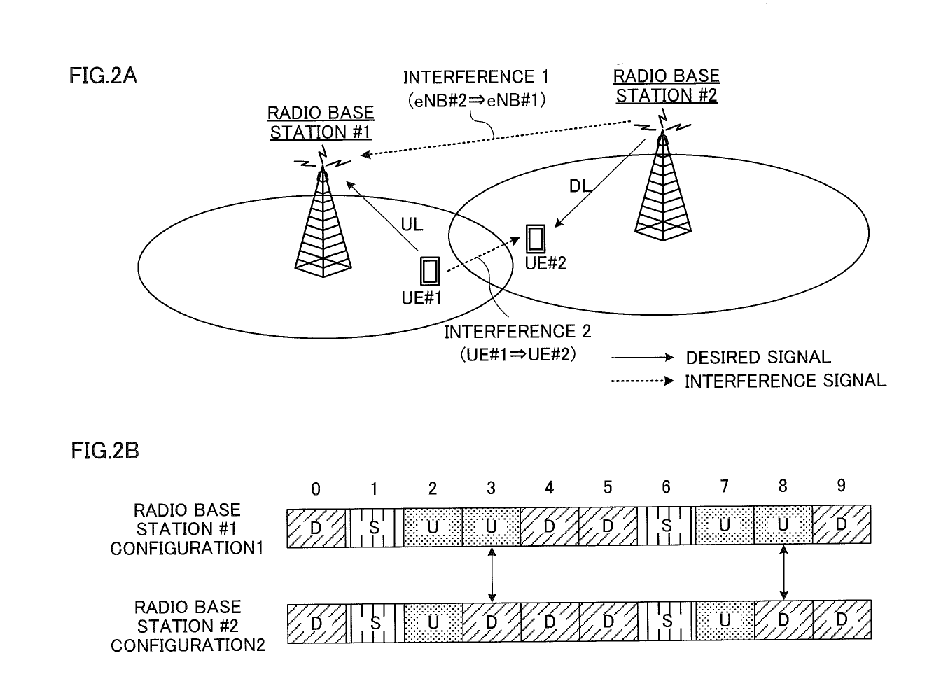

First, description is made about the case where, under application of TDD, DL and UL transmission rates are changed dynamically in the time domain per transmission/reception point (Dynamic TDD). The radio communication system illustrated in FIG. 2A is configured to include a plurality of transmission/reception points of the same operator (here, radio base stations #1, #2) and user terminals #1, #2 that communicate with the radio base stations #1, #2.

In FIG. 2A, radio communication is performed by time division duplex (TDD) between the radio base station #1 and the user terminal #1 and between the radio base station #2 and the user terminal #2. For example, as illustrated in FIG. 2B, it is assumed that the radio base station #1 uses the DL/UL configuration 1 and the radio base station #2 uses the DL/UL configuration 2.

In this case, in the subframes 3 and 8, the radio base station #1 performs UL transmission and the radio base station #2 performs DL transmission. That is, in the same time/frequency domain, the radio base station #2 transmits downlink signals to the user terminal #2 and the user terminal #1 transmits uplink signals to the radio base station #1.

Therefore, the downlink signals transmitted from the radio base station #2 to the user terminal #2 may cause interference to the uplink signals transmitted from the user terminal #1 to the radio base station #1 (interference 1 between the radio base station #1 and the radio base station #2). Besides, the uplink signals transmitted from the user terminal #1 to the radio base station #1 may cause interference to the downlink signals transmitted from the radio base station #2 to the user terminal #2 (interference 2 between the user terminal #1 to the user terminal #2)

As a result, in the subframes 3, 8, the reception quality of the radio base station #1 and the reception quality of the user terminal #2 may deteriorate. In general, transmission power of a downlink signal transmitted from the radio base station to the user terminal is greater than the transmission power of an uplink signal transmitted from the user terminal to the radio base station. Therefore, the downlink signal transmitted from the radio base station has a greater influence on the uplink signal (uplink control signal) transmitted from the user terminal (interference 1 in FIG. 2A) than vice versa.

Thus, when applying different DL/UL configurations to adjacent radio base stations, if a DL subframe and an UL subframe overlap one another, the influence of interference of the downlink signal on the uplink control channel (PUCCH) (interference between radio base stations) becomes larger, which may causes deterioration in communication quality.

Here, in the above-described example, the frequency carrier (hereinafter referred to as “frequency carrier #1”) used by the radio base station #1 and the user terminal #1 may be the same as or different from the frequency carrier (hereinafter referred to as “frequency carrier #2”) used by the radio base station #2 and the user terminal #2. When the frequency carrier #1 is different from the frequency carrier #2, the influence of such interference becomes smaller than the influence where the frequency carrier #1 is the same as the frequency carrier #2.

This is because, in the case where the frequency carrier #1 is different from the frequency carrier #2, interference is caused by unwanted emission occurring in an adjacent band when transmitting signals, not by the signal itself. In addition, not only the unwanted emission at the transmission side, but also adjacent channel selectivity and blocking property of a user terminal or a radio base station that receives interference also cause deterioration in communication quality.

In general, when the frequency carrier #1 is adjacent to the frequency carrier #2, the influence of such unwanted emissions, adjacent channel selectivity and blocking property is considered to be about 30 dB smaller than the interference caused when the frequency carrier #1 is the same as the frequency carrier #2. In addition, the larger the gap between the frequency carrier #1 and the frequency carrier #2, the smaller the influence of such interference becomes. The influence of such interference can be known by analogy from the definition about unwanted emission of the user terminal and the radio base station and definitions about adjacent channel selectivity/blocking property disclosed in 3GPP, TS 36.101 and TS 36.104.

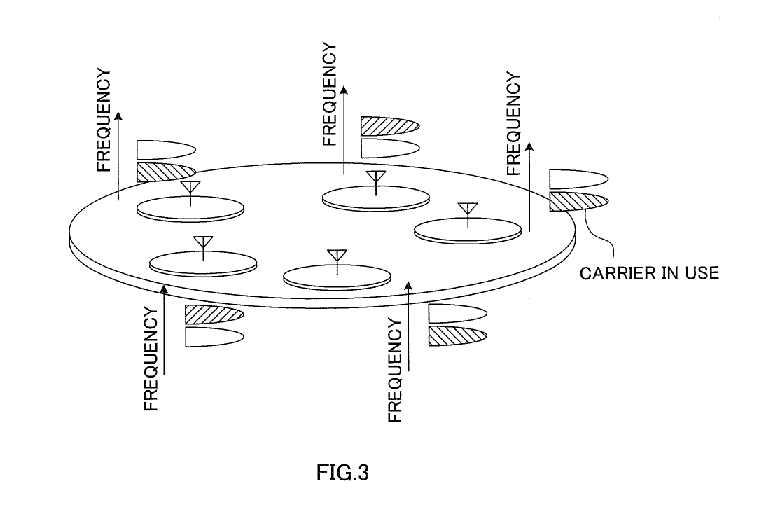

Accordingly, in order to reduce interference between radio base stations that are geographically adjacent to each other, there is considered the method of applying mutually different frequency carriers (RBs) to adjacent transmission/reception points. For example, as illustrated in FIG. 3, in a configuration where a plurality of small cells are provided, adjacent small cells are applied with frequency carriers (hereinafter, also referred to as “carriers” simply) that are orthogonal to each other in the frequency direction.

That is, each small cell performs dynamic TDD using radio resources of a different frequency from that of an adjacent small cell. With this configuration, it is possible to reduce interference between the adjacent radio base stations. However, in the case of FIG. 3, there occurs a frequency carrier (radio resources) that is not used by each small cell, which may reduce the use efficiency of radio resources.

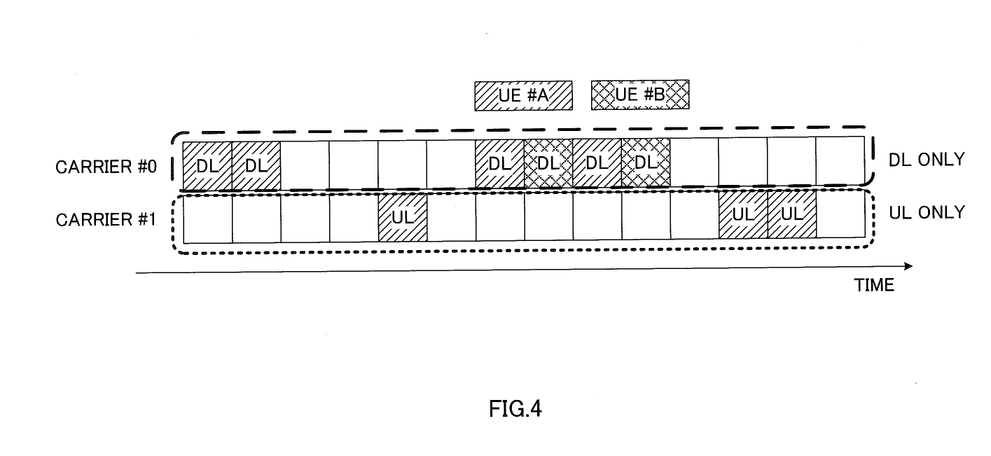

As another interference reduction method in dynamic TDD, use of the Half Duplex FDD mechanism is considered (Half Duplex FDD like). In this case, as illustrated in FIG. 4, carrier allocation is performed in such a manner that an UL carrier for uplink transmission is orthogonal in the frequency direction to a DL carrier for downlink transmission. In one transmission time interval (for example, in one subframe), either of the transmission direction for UL carrier and the transmission direction for DL carrier is used to perform transmission and reception of signals for one user terminal.

In FIG. 4, the radio base stations of the same operator perform communication using a DL carrier (carrier #0 in FIG. 4) and an UL carrier (carrier #1 in FIG. 4). Therefore, as compared with the case in FIG. 3, improvement of use efficiency of radio resources can be expected. In addition, UL transmission and DL transmission for one user terminal are performed using different carriers and different subframes. That is, each user terminal does not perform UL transmission and DL transmission simultaneously (in the same subframe).

On the other hand, each radio base station (for example, each small base station) is able to perform UL transmission and DL transmission simultaneously for different user terminals. Accordingly, a user terminal performs the Half Duplex operation and the radio base station performs the Full Duplex operation. In this way, by use of the Half Duplex FDD mechanism, it is possible to simplify the configuration of the user terminal (no duplexer is required) and also possible to use conventional user terminals supporting TDD. Also as compared with the case in FIG. 3, it is possible to improve use efficiency of radio resources.

In addition, in a future radio communication system, that is, in a HetNet environment where a coverage area of a small base station overlaps a coverage area of a macro base station, the small base station is considered to use the Half Duplex FDD mechanism. If Half Duplex FDD is used stand-alone, the scheduler of the small base station needs to perform scheduling control of packets in consideration that the user terminal receives MIB, SIB, paging signals or other common signals/channel.

Specifically, in a subframe where the user terminal is expected to receive MIB, SIB, paging signals or other common signals/channel, it is necessary to perform scheduling control of packets so as to prevent occurrence of UL transmission. Here, the small base station that operates on a stand-alone basis needs to use a certain resource area as a transmission area for MIB, SIB, paging signals or other common signals/channel in a fixed manner.

On the other hand, in the case where the user terminal is configured to be connected to both of the macro base station and the small base station (dual connectivity), cell-specific signals, channels about the small base station and the like are able to be transmitted from the macro base station to the user terminal. Therefore, the small base station can be configured not to transmit cell-specific signals and the like to the user terminal. Here, dual connectivity may be, specifically, Intra-eNB Carrier Aggregation or Inter-eNB Carrier Aggregation. In addition, such cell-specific signals and channels are, for example, above-mentioned MIB, SIB, paging signals or the like.

Further, in the small cell, when new carrier type (NCT) is applied to the cell, it is possible to eliminate the need to provide a fixed band in NCT and it is, therefore, possible to control the bandwidth for DL and UL transmission (DL/UL bandwidth) in a flexible manner.

Generally, in order for the radio base station to transmit cell-specific signals and channels, such as pilot signals, synchronization signals, MIB, SIB and paging signals, to the user terminal, it is necessary to fix the system bandwidths for DL and UL. This is because the user terminal needs to receive such cell-specific signals and channels even in an idle state where connection with a radio base station is not established. In such a case, such cell-specific signals and channels need to be transmitted in predetermined time-frequency resources. If the cell-specific signals and channels are thus transmitted in predetermined time/frequency resources, the system bandwidth is inevitably fixed. That is, in the new carrier type, if such cell-specific signals and channels are removed, it is possible to control the DL/UL bandwidth in a flexible manner.

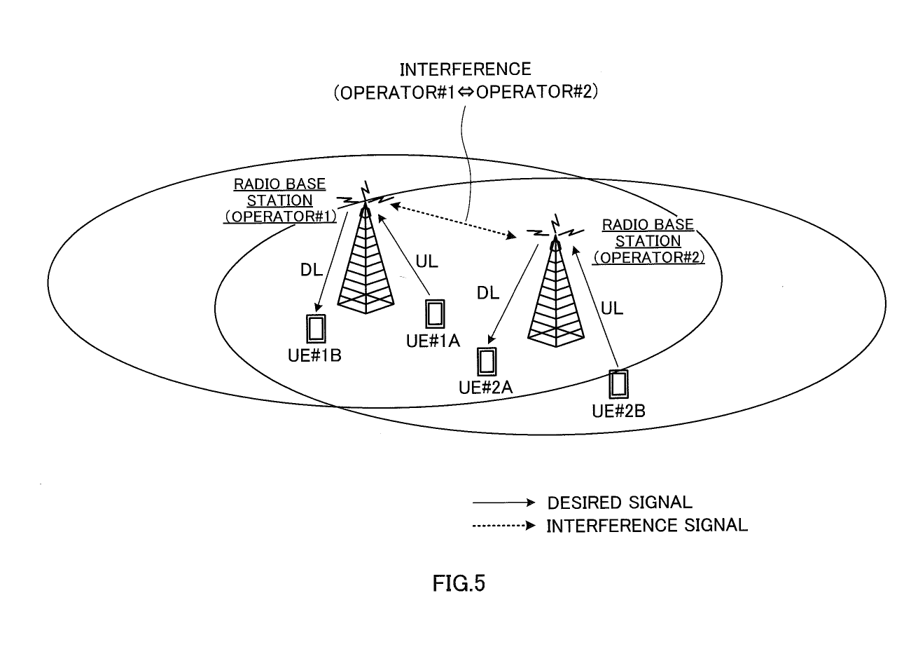

Here, in a future communication system, it is considered that a plurality of operators (telecommunication companies) provide mobile communication services using carriers of different frequencies in a certain frequency band (for example, 3.5 GHz band). These operators are considered to use the Dynamic TDD mechanism. Radio base stations of different operators are considered to have wide overlapping coverage areas than adjacent radio base stations of the same operator (see FIG. 5). In an extreme case, a radio base station of a certain operator may be located at the same location, for example, the same antenna tower, as a radio base station of another operator.

Accordingly, there occurs interference between carriers used by different operators (between adjacent carriers of different transmission directions), which may cause deterioration of channel quality. That is, in the conventional TDD, when each operator dynamically changes UL and DL time slots, or when the allocation rates of DL and UL time slots are changed dynamically, the influence of interference between adjacent carriers becomes large in the timing of different transmission directions. Such interference is caused by unwanted emission that occurs in an adjacent band or adjacent channel selectivity and blocking property at the receiving side as described above.

Further, not Dynamic TDD, but the conventional FDD mechanism may be considered to be used. In such a case, there is no interference between carriers used by the different operators, however, DL and UL resources could not be changed dynamically. That is, the conventional FDD mechanism involves a problem that the resources in the frequency direction cannot be changed dynamically.

Then, the present inventors have found that the influence of interference can be minimized by controlling allocation of adjacent carriers between different operators in consideration of interference given from a transmission/reception point (radio base station) of another operator, using the above-mentioned Half Duplex FDD mechanism. Specifically, allocation of UL and DL carriers is controlled so that adjacent carriers of different operators have the same transmission direction. Here, the adjacent carriers of different operators means, for example, that the first carrier allocated by the first operator and the second carrier allocated by the second operator are adjacent to each other without any other carrier between the first and second carriers in the frequency direction.

With reference to the accompanying drawings, the following description is made in detail about embodiments of the present invention. In the following description, it is assumed as an example that there are three operators that perform carrier allocation, but the number of operators applicable to the embodiments of the present invention is not limited to this.

### First Embodiment

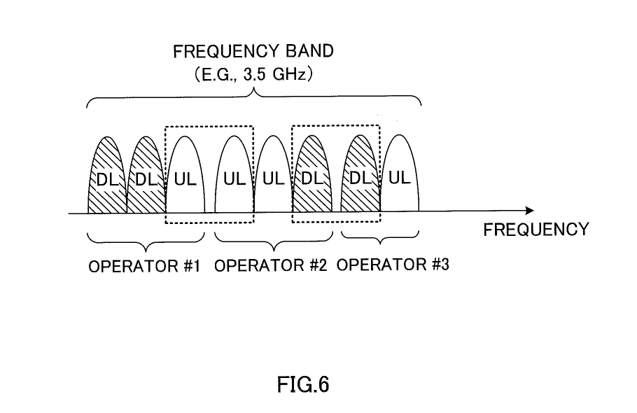

FIG. 6 illustrates carrier allocation according to the first embodiment using the Half Duplex FDD mechanism. FIG. 6 provides an example of UL and DL carriers which are configured in each operator (Operator #1 to Operator #3) in a certain transmission/reception timing (subframe).

The transmission/reception point (radio base station) of each operator performs carrier allocation in such a manner that UL carriers used for uplink transmission and DL carriers used for downlink transmission are orthogonal to each other in the frequency direction, as illustrated in FIG. 4.

Specifically, in a certain frequency band (for example, 3.5 GHz), operator #1 configures two DL carriers and one UL carrier in the low frequency region. Operator #2 configures one DL carrier and two UL carriers in the intermediate frequency region. Operator #3 configures one DL carrier and one UL carrier in the high frequency region. That is, carrier allocation is performed separately in the frequency direction for each operator. The number of carriers, bandwidth, position, order and the like configured by each operator are not limited to these. For example, the bandwidth does not have to be fixed for each carrier.

Further, carrier aggregation is performed in such a manner that adjacent carriers of different operators have the same transmission direction. For example, in FIG. 6, in the carriers used by the operator #1 and operator #2, adjacent carriers are used as UL carriers. In the carriers used by the operator #2 and operator #3, adjacent carriers are used as DL carriers.

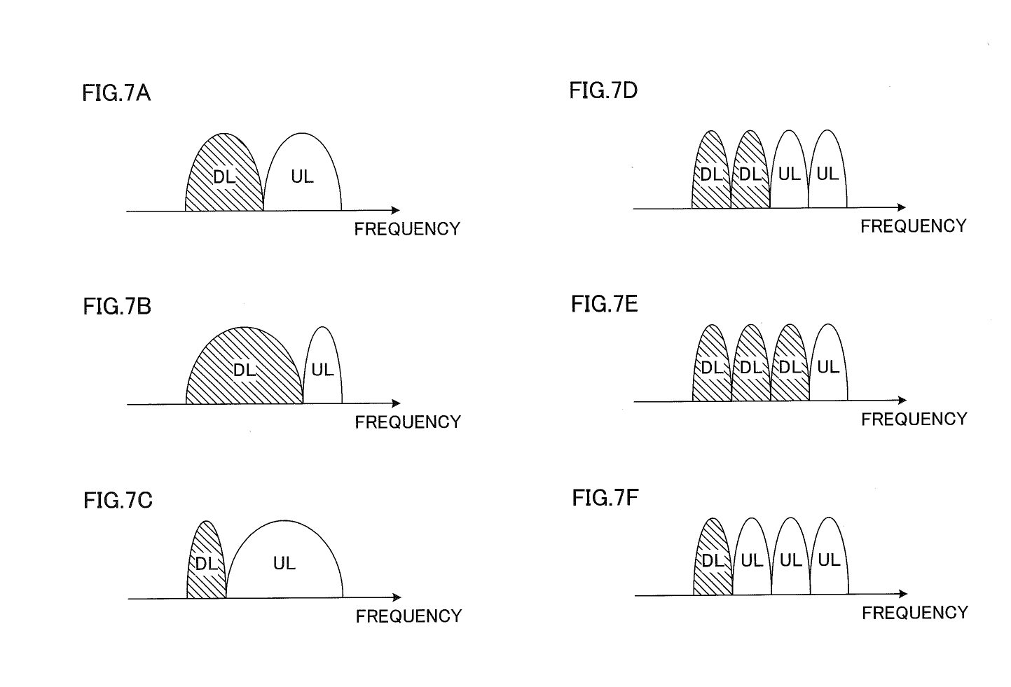

Furthermore, as illustrated in FIG. 7, each operator may control the bandwidths of UL and DL carriers and the number of carriers so as to change the resource allocation rate in the frequency direction dynamically. For example, as illustrated in FIGS. 7A to 7C, each operator may change the bandwidth for DL and UL transmissions dynamically in accordance with the amounts of traffic in DL and UL transmissions. Specifically, FIG. 7A illustrates an example of the carrier bandwidth where the DL transmission traffic and the UL transmission traffic are almost identical. FIG. 7B illustrates an example of the carrier bandwidth where the DL transmission traffic is greater than the UL transmission traffic. FIG. 7C illustrates an example of the carrier bandwidth where the DL transmission traffic is less than the UL transmission traffic.

Or, each operator may change, as illustrated in FIG. 7D to 7F, the number of carriers for DL and UL transmissions. Specifically, FIG. 7D illustrates an example of the number of UL transmission carries and the number of DL carriers where the DL transmission traffic and the UL transmission traffic are almost identical. FIG. 7E illustrates an example of the number of UL transmission carries and the number of DL carriers where the DL transmission traffic is greater than the UL transmission traffic. FIG. 7F illustrates an example of the number of UL transmission carries and the number of DL carriers where the DL transmission traffic is less than the UL transmission traffic.

Or, each operator may change both of the bandwidth and the number of carriers for DL and UL transmissions in accordance with the amount of traffic of DL and UL transmission. Here, adjustment and control of the bandwidth and the number of carriers for DL and UL transmissions may be called, more generally, resource control in the frequency direction for UL and DL transmissions. Or, adjustment and control of the bandwidth and the number of carriers for DL and UL transmissions may be called, more generally, control of resource allocation rate in the frequency direction for UL and DL transmissions.

Here, when changing the bandwidth and the number of carriers of each of UL and DL carriers, each operator also controls the bandwidth and the number of carriers in such a manner that adjacent carriers of different operators have the same transmission direction.

Thus, by making the adjacent carriers of the different operators have the same transmission direction, it is possible to reduce adjacent channel interference (ACI) between operators. As a result, even when each operator changes the resource allocation rate in the frequency direction for DL or UL transmission, it is possible to reduce interference given from the transmission/reception point of another operator.

Here, according to the first embodiment, it is only necessary that the transmission directions of adjacent carriers of different operators should be the same, and the resource allocation rates in the frequency direction for DL and UL transmissions in one operator may be determined independently by the operator itself. In the case illustrated in FIG. 6, among three carriers of the operator #1, the carrier that is adjacent to a carrier of the operator #2 has only to be controlled to have the same direction as the adjacent carrier, and the bandwidth of the carrier adjacent to the carrier of the operator #2 may be determined appropriately. The transmission direction and bandwidth of each carrier other than the carrier adjacent to the carrier of the operator #2 may be determined appropriately.

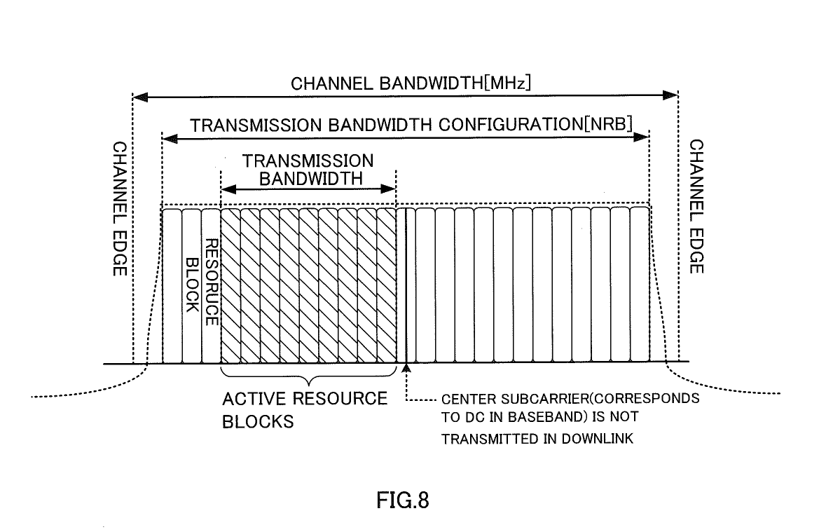

In addition, a gap between adjacent carriers of different operators may be determined to meet a predetermined condition. The predetermined condition is such that the gap is configured in accordance with the provisions in ACIR (Adjacent Channel Interference Ratio), and, for example, the gap may be configured to meet the ACIR value 30 dB. More specifically, the gap may be a gap configured in normal FDD or in TDD where time synchronization is achieved. For example, as illustrated in FIG. 8, the gap defined in terms of Transmission Bandwidth Configuration (N_{RB}) has only to be configured (see 3GPP TS 36.101 V11.3.0, FIGS. 5.6-1). FIG. 8 illustrates the relationship between channel bandwidth and transmission bandwidth configuration, and the transmission bandwidth is defined within the range of channel bandwidth. That is, from the viewpoint of the Channel Bandwidth, it is not necessary to provide a gap between adjacent carriers.

Further, the gap between carriers in one operator may be determined independently by the operator. Each operator may determine the gap in consideration of interference between user terminals controlled by the operator or radio base stations, or influence of self-interference within the radio base station. Here, the self-interference within the radio base station means interference given from transmission signals of the radio base station to a receiver of the radio base station. In general, isolation between the transmission point and the reception point of the radio base station is reserved sufficiently, but if the gap is small, such isolation may be hard to achieve. Therefore, the operator may determine the size of the gap in consideration of the difficulty of such isolation.

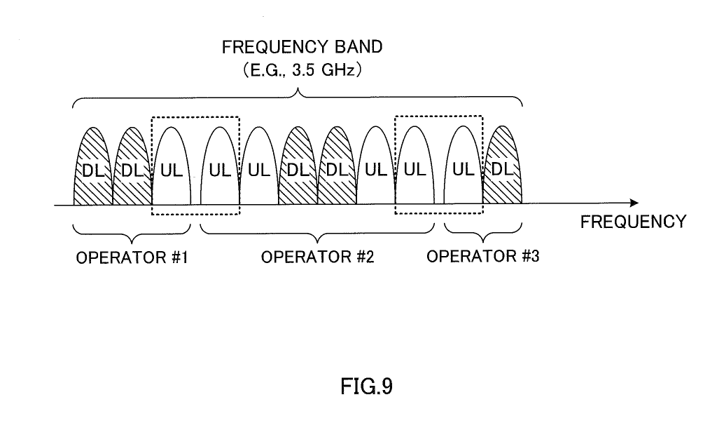

In addition, as illustrated above, if the transmission directions of adjacent carriers are controlled to be the same between different operators, the number of carriers, bandwidth, position, order and the like configured by each operator are not limited to these. For example, each operator may be able to perform carrier allocation as illustrated in FIG. 9.

In FIG. 9, in a certain frequency band (for example, 3.5 GHz), the operator #1 configures two DL carriers and one UL carrier in the low frequency region. The operator #2 configures two DL carriers and four UL carriers in the intermediate frequency region. The operator #3 configures one DL carrier and one UL carrier in the high frequency region. Further, in the carriers used by the operators #1 and #2, adjacent carriers are used as UL carriers. In carriers used by the operators #2 and #3, adjacent carriers are used as UL carriers.

### Second Embodiment

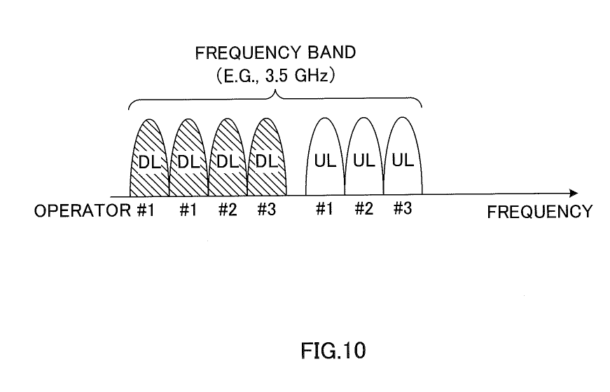

FIG. 10 illustrates carrier allocation according to the second embodiment using the Half Duplex FDD mechanism. FIG. 10 provides an example of allocation of UL and DL carriers configured at the operators in a certain transmission/reception timing (subframe).

In the second embodiment, carriers are configured in accordance with the transmission direction of each carrier (UL or DL) (see FIG. 10), not by dividing the frequency area per operator as illustrated in FIGS. 6 and 9 above. That is, the radio base station of each operator allocates a DL carrier to be adjacent to a DL carrier of another operator and allocates an UL carrier to be adjacent to an UL carrier of another operator. In this case, the radio base station of each operator configures one of the DL carrier and the UL carrier to the low frequency region side and configures the other of the DL carrier and the UL carrier to the high frequency region side.

In FIG. 10, in a certain frequency band (for example, 3.5 GHz band), the operator #1 configures two DL carriers in the low frequency region and one UL carrier in the high frequency region. The operator #2 configures one DL carrier in the low frequency region and one UL carrier in the high frequency region. The operator #3 configures one DL carrier in the low frequency region and configures one UL carrier in the high frequency region. That is, the DL carriers of the operators #1 to #3 are aggregated and allocated to the low frequency region side and the UL carriers of the operators #1 to #3 are aggregated and allocated to the high frequency region side.

As the DL carriers and UL carriers of the respective operators are aggregated to be allocated, it is possible to make the adjacent carriers of the different operators have the same transmission direction. This makes it possible to reduce interference between operators (ACI: Adjacent Channel Interference).

In addition, in the second embodiment, the resource allocation rates in the frequency direction of the DL and UL carriers may vary between the operators. For example, as illustrated in FIG. 10, only the operator #1 is able to configure two DL carriers.

Further, in FIG. 10, a gap between carriers of different transmission directions (between DL and UL carriers) is configured to meet a predetermined condition. As the predetermined condition, for example, the gap is configured in accordance with the above-mentioned ACIR provisions. More specifically, the gap configured may be a gap for normal FDD or a gap for TDD where time synchronization is established. For example, as illustrated in FIG. 8 explained above, it is only necessary to configure a gap that is defined in view of transmission bandwidth configuration (see 3GPP TS 36.101 V11.3.0, FIGS. 5.6-1). That is, the gap between adjacent carriers is not required from the viewpoint of Channel Bandwidth.

Here, the gap between adjacent carriers of the same transmission directions but of different operators may be configured to be smaller than a gap between adjacent carriers of different transmission directions. In this case, by allocating carriers of different operators in an aggregated manner in accordance with the transmission direction, it is possible to improve the use efficiency of radio resources.

### Third Embodiment

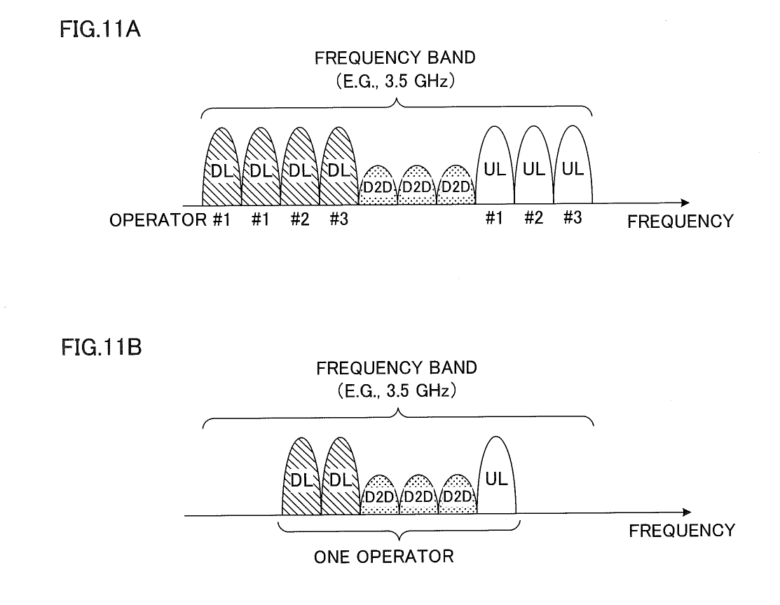

FIG. 11 illustrates carrier allocation according to the third embodiment using the Half Duplex FDD mechanism. FIG. 11 provides an example of UL carriers, DL carriers and D2D (Device to Device) carriers configured at respective operators in a certain transmission/reception timing (subframe).

In the third embodiment, a frequency (carriers or resource blocks) used for D2D is allocated to between DL carriers and UL carriers. In this case, each user terminal performs D2D communication using the D2D carrier frequency region.

As for D2D, judging from its property, there does not exist “DL transmission/UL transmission” as defined in normal communication between a user terminal and a radio base station. That is, in D2D, there is no idea of “different transmission directions” and there always occurs an interference problem that may be caused by the above-mentioned different transmission directions. On the other hand, in D2D communication, the transmission power is lower than that in communication between a user terminal and a radio base station. Therefore, such an interference problem is considered not so big. In other words, in D2D communication, it is general to control communication to be performed with transmission power that does not cause such interference.

Therefore, by configuring D2D carriers between two carriers of different transmission directions (particularly, between adjacent DL and UL carriers of different operators), it is possible to minimize interference between the operators. In addition, as the gap area between the carriers of different transmission directions can be used as a D2D carrier, it is possible to improve the use efficiency of radio resources.

For example, in each operator, when DL carriers are configured at low frequency region side and UL carriers are configured at the high frequency region side (see FIG. 10 explained above), D2D carriers are allocated between a DL carrier group and an UL carrier group (see FIG. 11A). Since the transmission power of the D2D carriers allocated between DL and UL carriers is low, it is possible to reduce the influence of interference of the communication using D2D carriers on the DL and UL carriers. Besides, the D2D carriers can be regarded as a guard band in terms of the interference with the DL and UL carriers, and it is possible to reduce the interference of the DL carriers with the UL carriers (or, the interference of the UL carriers with the DL carriers).

As illustrated in FIG. 11B, allocation of D2D carriers may be made between DL and UL carriers of an operator (for example, operator #1) in the first embodiment mentioned above. If D2D carriers are configured between DL and UL carriers, as with the case of FIG. 11A, it is possible to bring about the effects of improving use efficiency of radio resources and reduction of interference between carriers of different transmission directions.

### Fourth Embodiment

In the fourth embodiment, description is made about a method of notifying, by the transmission/reception point (radio base station) of each operator, a user terminal of allocation information for DL carries and UL carriers.

The transmission/reception point of each operator is able to designate DL and UL carrier for a user terminal by using RRC signaling. Specifically, allocation information of DL and UL carriers is able to be given to the user terminal at the timing of RRC connection reconfiguration (RRC CONNECTION RECONFIGURATION). The RRC connection reconfiguration includes notification information like CSI-RS configuration (CSI-RS Config). Here, the position of each carrier adopted by each operator may be determined in advance or may be configured to be changed dynamically or semistatically based on a predetermined condition. For example, the transmission direction of a carrier that is adjacent to a carrier of another operator may be changed in view of interference from the carrier of the other operator.

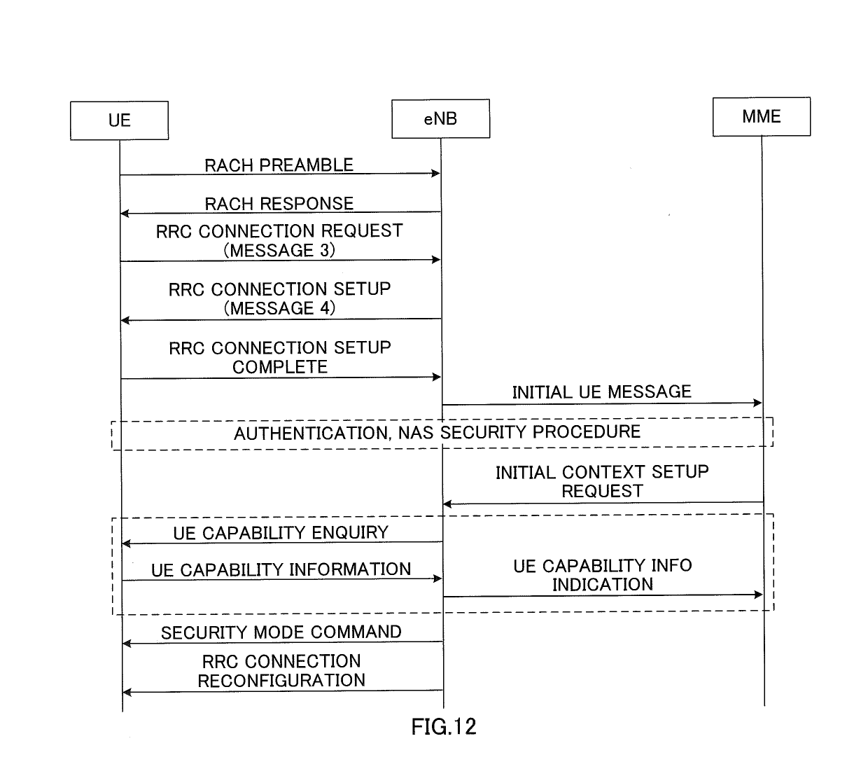

The following description is made, with reference to FIG. 12, about the case where allocation information of DL and UL carriers is given to the user terminal at the timing of RRC connection reconfiguration. First, the user terminal UE transmits RACH preamble to the radio base station eNB. Upon receiving the RACH preamble, the radio base station eNB transmits RACH response to the user terminal UE. Then, the user terminal UE transmits RRC CONNECTION REQUEST (Message 3) to the radio base station eNB. When receiving RRC CONNECTION REQUEST (Message 3), the radio base station eNB transmits RRC CONNECTION SETUP (Message 4) to the user terminal UE.

When receiving RRC CONENCTION SETUP (Message 4), the user terminal UE transmits RRC CONNECTION SETUP COMPLETE to the radio base station eNB. When receiving RRC CONNECTION SETUP COMPLETE, the radio base station eNB transmits INITIAL UE MESSAGE to a mobility management node (MME). Then, Authentication and NAS security procedure are performed between the user terminal UE and the mobility management node MME. After that, the mobility management node MME transmits INITIAL CONTEXT SETUP REQUEST to the radio base station eNB.

Here, if INITIAL CONTEXT SETUP REQUEST does not include UE CAPABILITY, the radio base station eNB transmits UE CAPABILITY ENQUIRY to the user terminal UE. When receiving UE CAPABILITY ENQUIRY, the user terminal UE transmits UE CAPABILITY INFORMATION to the radio base station eNB.

Then, the radio base station eNB transmits UE CAPABILITY INFO INDICATION to the mobility management node MME. Next, the radio base station eNB transmits SECURITY MODE COMMAND to the user terminal UE. After that, the radio base station eNB transmits, to the user terminal UE, RRC CONNECTION RECONFIGURATION including information to designate UL and DL carriers.

As the method for designating UL and DL carriers, MIB or SIB may be used, or downlink control channel (PDCCH, EPDCCH) may be used. In the case of using the downlink control channel, the user terminal may be notified in advance of candidates for allocation of UL and DL carriers by higher layer signaling (for example, RRC signaling) thereby to be able to designate a carrier from the plural candidates dynamically by downlink control information (DCI).

Besides, the radio base station of each operator may be configured to change designation positions of UL and DL carriers based on information about a user terminal located in the serving area, traffic load, interference between DL carrier and UL carrier, and so on.

Here, if HetNet is applied including a macro base station and a small base station, it is preferable to change an entity (macro base station or small base station) that notifies the user terminal of the above-mentioned allocation information of DL and UL carriers in accordance with a communication type (Half Duplex FDD or standalone).

For example, in the HetNet including a macro base station and a small base station, assume that the user terminal performs communication with the macro base station and the small base station using dual connectivity and the small base station performs communication using the Half Duplex TDD mechanism. That is, the small base station is assumed not to operate as stand-alone. In such a case, as dual connectivity (Intra-eNB Carrier Aggregation or Inter-eNB Carrier Aggregation) is applied, the macro base station is able to notify the user terminal by using the above-mentioned RRC signaling. That is, the macro base station serves as a base station that notifies the user terminal the Half Duplex FDD configuration and the small base station servers as a base station that executes communication using the Half Duplex FDD mechanism.

On the other hand, if the small base station operates stand-alone, the small base station operates independently and transmits, to the user terminal, cell-specific signals and channels such as pilot signals, synchronization signals, MIB, SIB and paging signals. Accordingly, a scheduler of the small base station performs packet scheduling in consideration of reception of common signals/channels such as MIB, SIB and paging signals by the user terminal. That is, the small base station serves as a base station to notify the user terminal of Half Duplex FDD configuration and perform communication using the Half Duplex FDD mechanism. Each communication type will be in detail below.

In the HetNet environment including a macro base station and a small base station, when dual connectivity (for example, CA) is applied, operation of the system using the Half Duplex FDD mechanism is considered to be performed in SCell (for example, small cell (3.5 GHz band)). SCell may be called secondary cell or sub cell. In this case, RRC signaling may be performed using PCell (for example, macro cell (2 GHz band)). PCell may be called primary cell.

In this case, as described above, the macro base station notifies the user terminal of predetermined information by RRC signaling and the small base station notifies the user terminal of other information using a downlink control channel (for example, EPDCCH), thereby to be able to designate frequency resources for the UL and DL carriers. In this case, RRC signaling can be transmitted from the macro base station and the downlink control channel can be transmitted from the small base station under control of the macro base station.

Specifically, the macro base station designates an allocation position of PRACH, an allocation position of EPDCCH, an allocation position of a DL pilot signal (at least one of PSS/SSS, CRS and discovery signal). In addition, the macro base station may notify the user terminal of frequency resources that can be transmitted on UL (or frequency resources that cannot be transmitted on UL), in consideration of PDCCH False alarm, by RRC signaling.

Next description is made about the case where the radio base station (for example, a small base station in HetNet including a macro base station and the small base station) performs the operation of Half Duplex FDD like as stand-alone.

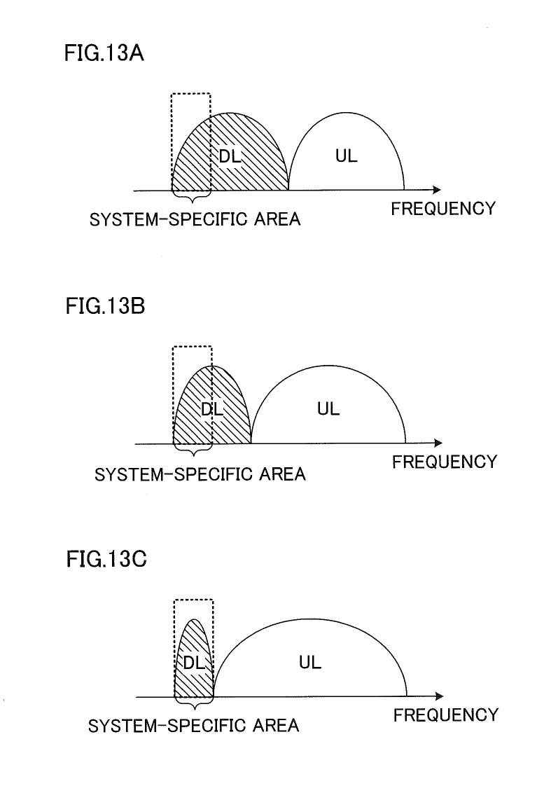

In the case of the stand-alone radio base station, a cell-specific signal or channel is transmitted in a predetermined area (system-specific area) that is determined in advance for the system (see FIG. 13A). For example, downlink synchronization signals and broadcast information are considered to be transmitted in a predetermined allocation position that is determined in advance within the system band (system-specific area). When such a stand-alone type radio base station performs the Half Duplex FDD like operation, for example, an area to transmit downlink cell-specific signals and channel is configured in advance as a radio resource dedicated to downlink thereby to prevent it from being used as an uplink radio resource, as illustrated in FIG. 13.

For example, when the traffic for DL transmission is less than the traffic for UL transmission, the system-specific area for downlink is configured not to be allocated with UL carrier, even when increasing the bandwidth for UL carrier (or the number of UL carriers) (see FIGS. 13B, 13C). Likewise, in the uplink transmission, a radio resource dedicated to uplink is also configured in advance thereby to prevent it from being used as a downlink radio resource.

As described above, the method of the fourth embodiment can be applied to the above-described first to third embodiments appropriately.

### (Configuration of Radio Communication System)

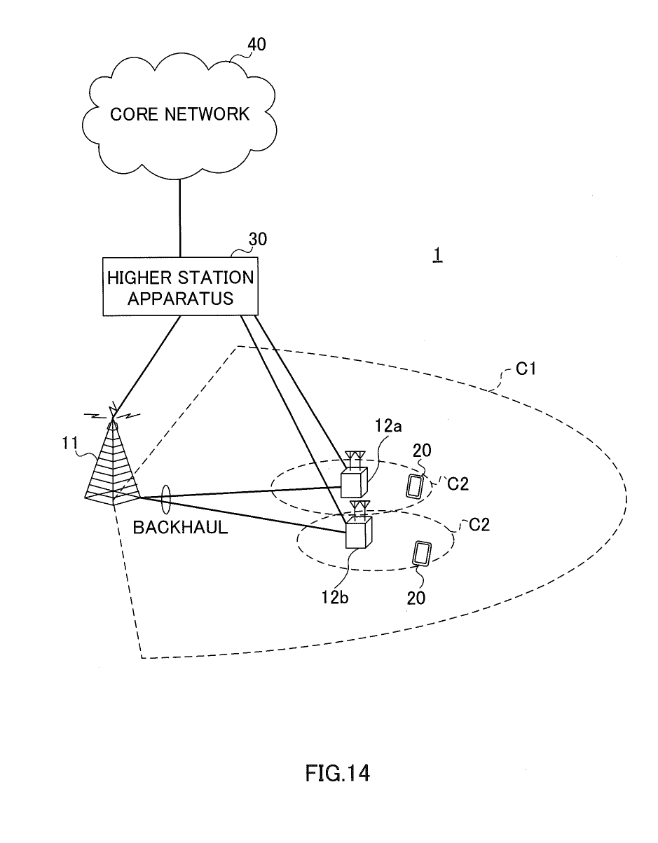

FIG. 14 is a schematic diagram illustrating the radio communication system according to the present embodiment. For example, the radio communication system illustrated in FIG. 14 is an LTE system or a system comprising a SUPER 3G. In this radio communication system, carrier aggregation (CA) can be applied in which a plurality of base frequency blocks (component carriers) are aggregated, each component carrier being a unit of system band of the LTE system. This radio communication system may be called IMT-Advanced, 4G, or FRA (Future Radio Access).

The radio communication system 1 illustrated in FIG. 14 includes a radio base station 11 forming a macro cell C1, and radio base stations 12a and 12b that are arranged within the macro cell C1 and each form a smaller cell C2 than the macro cell C1. In the macro cell C1 and small cells C2, user terminals 20 are located. Each user terminal 20 is able to be connected to both of the radio base station 11 and the radio base stations 12 (dual connectivity). The system in FIG. 14 is the radio communication system operated by the same operator and other operators are also able to have like system configurations.

The following description is made assuming that, in HetNet including the radio base station 11 (macro base station) and the radio base stations 12 (small base stations), when a small base station communicates using the Half Duplex FDD mechanism, the small base station does not operate stand-alone. That is, it is assumed that dual connectivity (Intra-eNB Carrier Aggregation or Inter-eNB Carrier Aggregation) is applied, the macro base station operates as a base station that notifies the user terminal of the Half Duplex FDD configuration and the small base station operates as a base station that performs communication using the Half Duplex FDD mechanism. Needless to say, the present invention is limited to this and may be embodied in such a form that the small base station operates stand-alone as described above.

Communication between the user terminal 20 and the radio base station 11 is performed by using a carrier of a relatively low frequency band (for example, 2 GHz) and a narrow bandwidth (such a carrier is an existing carrier also called “legacy carrier”). On the other hand, the communication between the user terminal 20 and a radio base station 12 may be performed by using a carrier of a relatively high frequency band (for example, 3.5 GHz) and a broad bandwidth or by using the same carrier as communication with the radio base station 11. As the carrier type between the user terminal 20 and the radio base station 12, new carrier type (NCT) may be used. The radio base station 11 and each radio base station 12 are connected to each other wiredly (optical fiber, X2 interface or the like) or wirelessly.

The radio base stations 11 and 12 are connected to a higher station apparatus 30, and are also connected to a core network 40 via the higher station apparatus 30. The higher station apparatus 30 includes, but is not limited to, an access gateway apparatus, a radio network controller (RNC), a mobility management entity (MME). Each radio base station 12 may be connected to the higher station apparatus via the radio base station 11.

The radio base station 11 is a radio base station having a relatively wide coverage area and may be called eNodeB, macro base station, transmission point or the like. The radio base station 12 is a radio base station having a local coverage area and may be called small base station, pico base station, femto base station, Home eNodeB, RRH (Remote Radio Head), micro base station, transmission point or the like. In the following description, the radio base stations 11 and 12 are collectively called radio base station 10, unless they are described discriminatingly. Each user terminal 20 is a terminal supporting various communication schemes such as LTE, LTE-A and the like and may comprise not only a mobile communication terminal, but also a fixed or stationary communication terminal.

When the small base station and the macro base station are connected by an optical fiber, the small base station is an RRH (Remote Radio Head) connected to the macro base station and the user terminal establishes connection simultaneously with the small base station and the macro base station, Intra-eNB carrier aggregation is applied to between the user terminal 20 and the macro base station, the small base station. When the small base station is not Remote Radio Head connected to the macro base station but one radio base station, and the user terminal establishes connection simultaneously with the small base station and the macro base station, inter-NB carrier aggregation is applied to between the user terminal 20, the macro base station and the small base station.

In the radio communication system, as multi access schemes, OFDMA (Orthogonal Frequency Division Multiple Access) is adopted for the downlink and SC-FDMA (Single Carrier Frequency Division Multiple Access) is adopted for the uplink. OFDMA is a multi-carrier transmission scheme to perform communication by dividing a frequency band into a plurality of narrow frequency bands (subcarriers) and mapping data to each subcarrier. SC-FDMA is a single carrier transmission scheme to perform communications by dividing, per terminal, the system band into bands formed with one or continuous resource blocks, and allowing a plurality of terminals to use mutually different bands thereby to reduce interference between terminals.

Here, description is made about communication channels used in the radio communication system illustrated in FIG. 14. As for downlink communication channels, there are used a PDSCH (Physical Downlink Shared Channel) that is used by each user terminal 20 on a shared basis and downlink L1/L2 control channels (PDCCH, PCFICH, PHICH, enhanced PDCCH). The PDSCH is used to transmit user data and higher control information. The PDCCH (Physical Downlink Control Channel) is used to transmit PDSCH and PUSCH scheduling information and so on. PCFICH (Physical Control Format Indicator Channel) is used to transmit the number of OFDM symbols used in PDCCH. PHICH (Physical Hybrid-ARQ Indicator Channel) is used to transmit HARQ ACK/NACK for PUSCH. Enhanced PDCCH (EPDCCH) may transmit PDSCH and PUSCH scheduling information and so on. EPDCCH may be frequency-division-multiplexed with PDSCH (Physical Downlink Shared Channel).

As for the uplink communication channels, there are used a PUSCH (Physical Uplink Shared Channel) that is used by each user terminal 20 on a shared basis and a PUCCH (Physical Uplink Control Channel) as an uplink control channel. The PUSCH is used to transmit user data and higher control information. And, PUCCH is used to transmit downlink radio quality information (CQI: Channel Quality Indicator), ACK/NACK and so on.

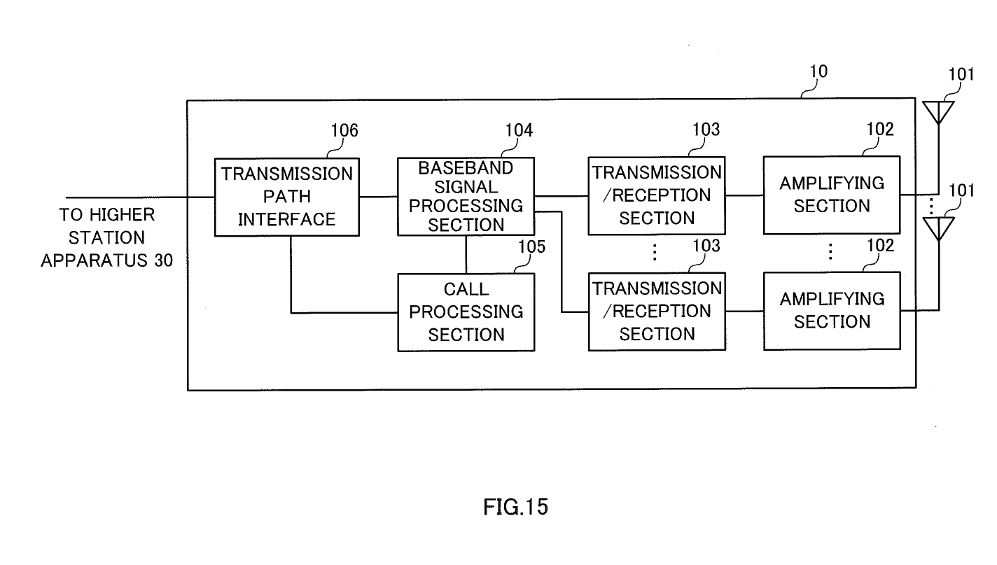

FIG. 15 is a diagram illustrating an overall configuration of the radio base station 10 (comprising the radio base stations 11 and 12) according to the present embodiment. The radio base station 10 is configured to have a plurality of transmission/reception antennas 101 for MIMO transmission, amplifying sections 102, transmission/reception sections 103, a baseband signal processing section 104, a call processing section 105 and a transmission path interface 106.

User data that is to be transmitted on the downlink from the radio base station 10 to the user terminal 20 is input from the higher station apparatus 30, through the transmission path interface 106, into the baseband signal processing section 104.

In the baseband signal processing section 204, signals are subjected to PDCP layer processing, RLC (Radio Link Control) layer transmission processing such as division and coupling of user data and RLC retransmission control transmission processing, MAC (Medium Access Control) retransmission control, including, for example, HARQ transmission processing, scheduling, transport format selection, channel coding, inverse fast Fourier transform (IFFT) processing, and precoding processing, and resultant signals are transferred to the transmission/reception sections 103. As for signals of the physical downlink control channel, transmission processing is performed, including channel coding and inverse fast Fourier transform, and resultant signals are also transferred to the transmission/reception sections 103.

Also, the baseband signal processing section 104 notifies each user terminal 20 of control information for communication in the corresponding cell by a broadcast channel. Information for communication in the cell includes, for example, uplink or downlink system bandwidth. When the radio base station 12 performs communication using the Half Duplex FDD mechanism, the radio base station 11 may notify the user terminal of allocation information of UL and DL carriers using a broadcast channel.

In the transmission/reception sections 103, baseband signals that are precoded per antenna and output from the baseband signal processing section 104 are subjected to frequency conversion processing into a radio frequency band. The frequency-converted radio frequency signals are amplified by the amplifying sections 102 and then, transmitted from the transmission/reception antennas 101. Here, when the radio base station 12 uses the Half Duplex FDD mechanism, the transmissions/reception sections 103 of the radio base station 12 (small base station) perform transmission and reception of signals using either one transmission direction of the UL carrier and DL carrier (using UL or DL carrier) for one user terminal in one transmission time interval (1 subframe).

Each of the transmission/reception sections 103 of the radio base station 11 (macro base station) serves as a transmission section configured to transmit allocation information of UL and DL carriers and the like. In addition, the macro base station is able to control the UL and DL carriers that are allocated by the small base station.

Meanwhile, as for data to be transmitted on the uplink from the user terminal 20 to the radio base station 10, radio frequency signals are received in the transmission/reception antennas 101, amplified in the amplifying sections 102, subjected to frequency conversion and converted into baseband signals in the transmission/reception sections 103, and are input to the baseband signal processing section 104.

The baseband signal processing section 104 performs FFT processing, IDFT processing, error correction decoding, MAC retransmission control reception processing, and RLC layer and PDCP layer reception processing on the user data included in the baseband signals received on the uplink. Then, the signals are transferred to the higher station apparatus 30 through the transmission path interface 106. The call processing section 105 performs call processing such as setting up and releasing a communication channel, manages the state of the radio base station 10 and manages the radio resources.

Thus, if the small base station that communicates using the Half Duplex FDD mechanism does not operate stand-alone, the transmission/reception sections 103 of the macro base station notify the user terminal of the Half Duplex FDD configuration and the small base station executes Half Duplex FDD like communications. In this case, allocation of UL and DL carriers in the small base station is configured to be controlled at the macro base station side.

On the other hand, if the small base station that communicates using the Half Duplex FDD mechanism operates stand-alone, the transmission/reception sections 103 of the small base station transmits, to the user terminal, cell-specific signals and channels such as pilot signals, synchronization signals, MIB, SIB and paging signals. In this case, the baseband signal processing section of the small base station may configure in advance the area to transmit cell-specific signals and channels on downlink as a downlink radio resource (radio resource dedicated to downlink), as illustrated in FIG. 13 mentioned above. The same goes for uplink.

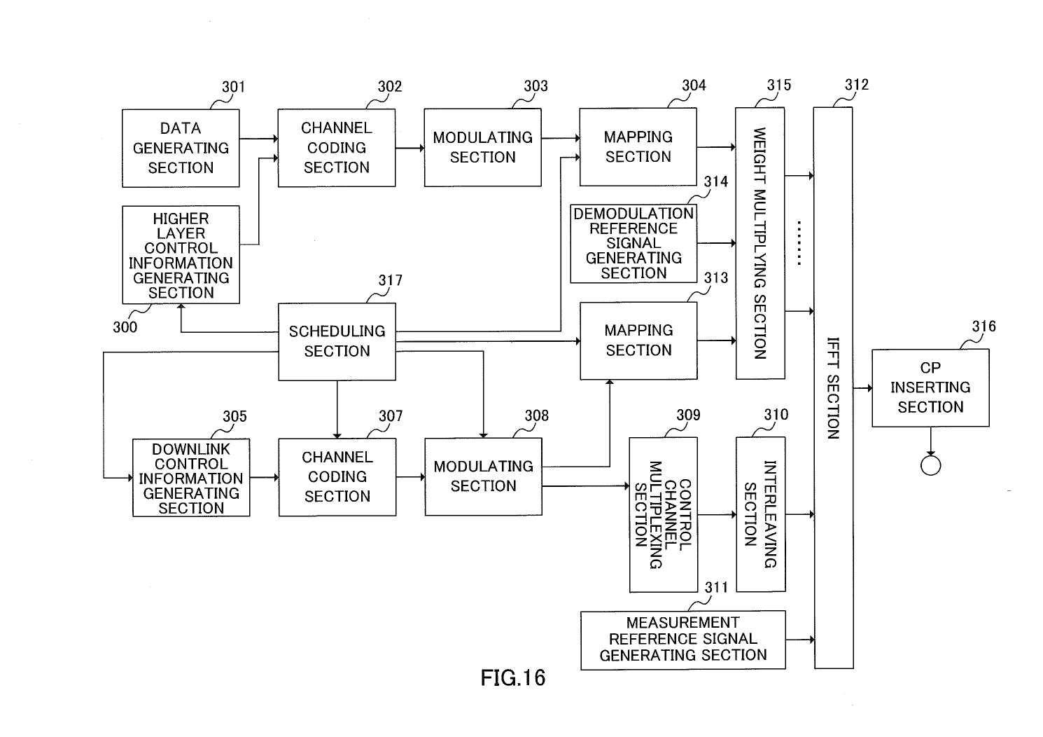

FIG. 16 is a diagram illustrating the functional configurations of the baseband signal processing section 104 provided in the radio base station 10 according to the present embodiment, and a part of the higher layers. Note that, although FIG. 16 primarily shows downlink (transmission) functional configurations, the radio base station 10 may have uplink (reception) functional configurations as well.

As illustrated in FIG. 16, the radio base station 10 has a higher layer control information generating section 300, a data generating section 301, a channel coding section 302, a modulating section 303, a mapping section 304, a downlink control information generating section 305, a channel coding section 307, a modulating section 308, a control channel multiplexing section 309, an interleaving section 310, a measurement reference signal generating section 311, an IFFT section 312, a mapping section 313, a demodulation reference signal generating section 314, a weight multiplying section 315, a CP inserting section 316 and a scheduling section 317.

The higher layer control information generating section 300 generates higher layer control information on a per user terminal 20 basis. Also, the higher layer control information is control information that is sent by higher layer signaling (for example, RRC signaling), and includes, for example, allocation information of UL and DL carriers and so on.

As one example, it is assumed that the user terminal 20 is connected to both of the radio base station 11 and the radio base station 12 (dual connectivity) and the radio base station 12 performs communication using the Half Duplex FDD mechanism as SCell. In this case, RRC signaling including UL and DL carriers can be transmitted from the radio base station 11 (macro base station) that acts as PCell. On the other hand, when the small base station that performs communication using the Half Duplex FDD mechanism operates stand-alone, such RRC signaling can be transmitted from the radio base station 12 (small base station).

The data generating section 301 generates downlink user data on a per user terminal 20 basis. The downlink user data that is generated in the data generating section 301 and the higher layer control information that is generated in the higher layer control information generating section 300 are input to the channel coding section 302 as downlink data to be transmitted in the PDSCH. The channel coding section 302 performs channel coding on the downlink data for each user terminal 20 in accordance with coding rates that are determined based on feedback information from each user terminal 20. The modulating section 303 modulates the channel-coded downlink data in accordance with modulation schemes that are determined based on feedback information from each user terminal 20. The mapping section 304 maps the modulated downlink data in accordance with instructions from the scheduling section 317.

The downlink control information generating section 305 generates downlink control information (DCI) on a per user terminal 20 basis. The downlink control information includes. PDSCH allocation information (DL assignment), PUSCH allocation information (UL grant) and so on. The downlink control information generating section 305 generates the downlink control information by using a predetermined DCI format (for example, DCI format 2D), in accordance with the mode of communication with the user terminals. When the allocation information of UL and DL carriers is given to the user terminal by using downlink control information, the downlink control information generating section 305 generates the allocation information based on the information from the scheduling section 317.

The downlink control information that is generated in the downlink control information generating section 305 is input in the channel coding section 307 as downlink control information to be transmitted in the PDCCH or the enhanced PDCCH. The channel coding section 307 performs channel coding of the downlink control information received as input, in accordance with coding rates designated by the scheduling section 317, which will be described later. The modulating section 308 modulates the channel-coded downlink control information in accordance with modulation schemes designated by the scheduling section 317.

Here, the downlink control information to be transmitted in the PDCCH is input from the modulating section 308 into the control channel multiplexing section 309 and multiplexed. The downlink control information that is multiplexed in the control channel multiplexing section 309 is interleaved in the interleaving section 310. The interleaved downlink control information is input to the IFFT section 312, with measurement reference signals (CSI-RSs, CRSs and so on) generated in the measurement reference signal generating section 311.

Meanwhile, the downlink control information to be transmitted in the enhanced PDCCH is input from the modulating section 308 into the mapping section 313. The mapping section 313 maps the downlink control information in accordance with instructions from the scheduling section 317, which will be described later.

The mapped downlink control information is input to the weight multiplying section 315, with the downlink data to be transmitted in the PDSCH (that is, the downlink data mapped in the mapping section 304) and the demodulation reference signals (DM-RSs) generated in the demodulation reference signal generating section 314. The weight multiplying section 315 multiplies the downlink data to be transmitted in the PDSCH, the downlink control information to be transmitted in the enhanced PDCCH, and the demodulation reference signals, by user terminal 20-specific precoding weights, and performs precoding on them. The precoded transmission data is input in the IFFT section 312, and converted from frequency domain signals to time sequence signals through inverse fast Fourier transform. Cyclic prefixes (CPs) to function as guard intervals are inserted in the output signals from the IFFT section 312 by the CP inserting section 316, and the signals are output to the transmission/reception sections 103.

The scheduling section 317 schedules the downlink user data to be transmitted in the PDSCH, the downlink control information to be transmitted in the enhanced PDCCH, and the downlink control information to be transmitted in the PDCCH. To be more specific, the scheduling section 317 allocates radio resources based on instruction information from the higher station apparatus 30 and feedback information from each user terminal 20 (for example, CSI (Channel State Information), which includes CQIs (Channel Quality Indicators), RIs (Rank Indicators) and so on).

For example, assume that the small base station that communicates using the Half Duplex FDD mechanism does not operate stand-alone and the user terminal is connected to both of the small base station and the macro base station (dual connectivity). When the small base station operates as an RRH (Remote Radio Head) (Intra-eNB Carrier Aggregation), the UL and DL carriers allocated by the small base station is able to be controlled by the scheduling section 317 of the macro base station. In this case, the small base station is able to control allocation of UL and DL carriers based on information from the macro base station.

Further, if the small base station is not the Remote Radio Head connected to the macro base station, but is one radio base station (Inter-eNB Carrier Aggregation), the UL and DL carriers allocated by the same base station is able to be controlled by the scheduling section 317 of the small base station. As described above, RRC signaling is able to be performed via the transmission/reception sections 103 of the macro base station.

On the other hand, when the small base station that communicates using the Half Duplex FDD mechanism operates stand-alone, allocation of the UL and DL carriers by the small base station is able to be controlled by the scheduling section 317 of the small base station.

Thus, the scheduling section 317 of each radio base station serves as an allocation control section configured to control allocation of UL and DL carriers in accordance with the communication mode. For example, the scheduling section 317 controls carrier allocation so that among carriers to allocate, a carrier adjacent to a carrier of another operator can have the same transmission direction as the carrier of the other operator (see the above-described first and second embodiments).

Further, the scheduling section 317 controls carrier allocation so as to provide a predetermined gap against an adjacent carrier of a different operator. Furthermore, the scheduling section 317 may allocate DL and UL carriers by providing a D2D (Device to Device) carrier between two carriers (see the above-described third embodiment). The scheduling section 317 may dynamically change the resource allocation rates of DL and UL carriers in the frequency direction in the same operator, as illustrated in FIG. 7.

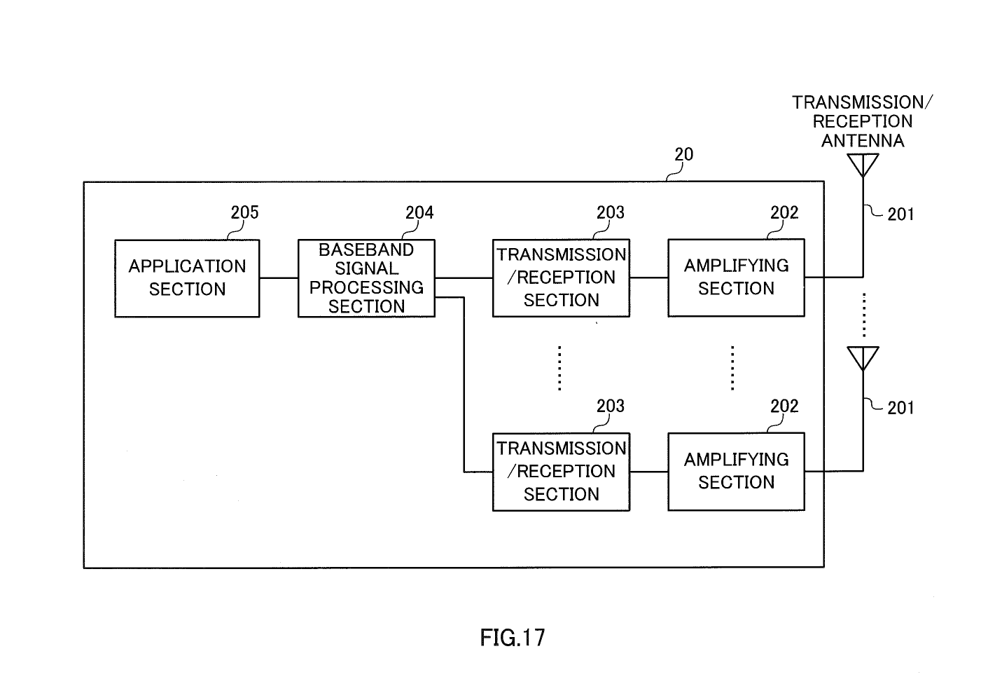

FIG. 17 is a diagram illustrating the overall configuration of the user terminal 20 according to the present embodiment. The user terminal 20 is configured to have transmission/reception antennas 201 for MIMO transmission, amplifying sections 202, transmission/reception sections (reception sections) 203, a baseband signal processing section 204, and an application section 205.

As for the downlink data, radio frequency signals received by the transmission/reception antennas 201 are amplified in the amplifying sections 202, and then, subjected to frequency conversion and converted into baseband signals in the transmission/reception sections 203. These baseband signals are subjected to FFT processing, error correction coding, reception processing for retransmission control and so on in the baseband signal processing section 204. In this downlink data, downlink transmission data is transferred to the application section 205. The application section 205 performs processing related to higher layers above the physical layer and the MAC layer. In the downlink data, broadcast information is also transferred to the application section 205.

On the other hand, uplink user data is input from the application section 205 to the baseband signal processing section 204. In the baseband signal processing section 204, retransmission control (H-ARQ: Hybrid ARQ) transmission processing, channel coding, precoding, DFT processing, IFFT processing and so on are performed, and the resultant signals are transferred to the transmission/reception sections 203. In the transmission/reception sections 203, the baseband signals output from the baseband signal processing section 204 are subjected to frequency conversion and converted into a radio frequency band. After that, the frequency-converted radio frequency signals are amplified in the amplifying sections 202, and then, transmitted from the transmission/reception antennas 201.

Here, each transmission/reception section 203 serves as a reception section configured to receive allocation information of UL and DL carriers transmitted from the radio base station, and the like.

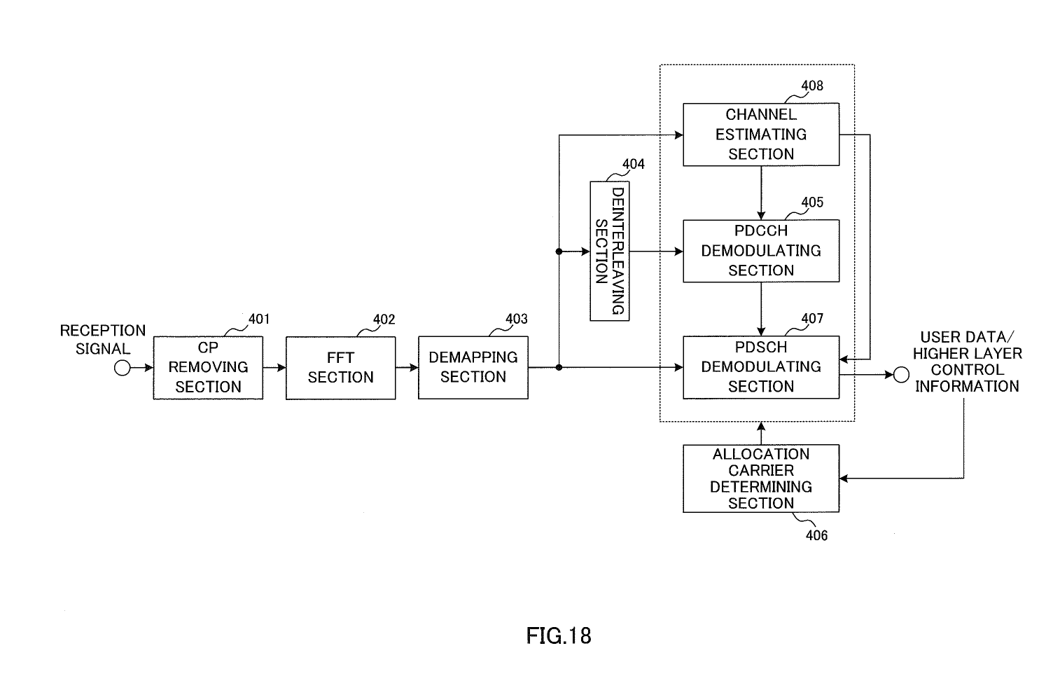

FIG. 18 is a diagram illustrating functional configurations of the baseband signal processing section 204 provided in the user terminal 20. The user terminal 20 has, as downlink (reception) functional configurations, a CP removing section 401, an FFT section 402, a demapping section 403, a deinterleaving section 404, a PDCCH demodulating section 405, an allocation carrier determining section 406, a PDSCH demodulating section 407 and a channel estimation section 408.

Downlink signals received from the radio base station 10 as received data are subjected to removal of cyclic prefixes (CPs) in the CP removing section 401. The CP-removed downlink signals are input in the FFT section 402. The FFT section 402 performs fast Fourier transform (FFT) of the downlink signals, converts the time domain signals into frequency domain signals, and inputs these signals to the demapping section 403. The demapping section 403 demaps the downlink signals. Note that the demapping process in the demapping section 403 is performed based on higher layer control information that is input from the application section 205. Downlink control information that is output from the demapping section 403 is deinterleaved in the deinterleaving section 404.

The PDCCH demodulating section 405 performs blind decoding, demodulation, channel decoding and so on of the downlink control information (DCI) output from the deinterleaving section 404, based on the results of channel estimation in the channel estimation section 408, which will be described later.

When the radio base station 12 uses the Half Duplex FDD mechanism, the allocation carrier determining section 406 determines an allocation carrier based on the allocation information of UL and DL carriers received from the radio base station 11 or radio base station 12. With this structure, even when the resource allocation rate of the UL or DL carriers in the frequency direction is changed dynamically, the user terminal is able to specify the carrier to use.

Here, in FIG. 18, the allocation carrier determining section 406 determines an allocation carrier based on the carrier allocation information received by RRC signaling, but this is not intended for limiting the present invention. When the carrier allocation information is included in the downlink control information, the allocation carrier determining section 406 is able to determine an allocation carrier based on the information output from the PDCCH demodulating section 405. Or, the allocation carrier determining section 406 may determine an allocation carrier based on both of RRC signaling and downlink control information.

The PDSCH demodulating section 407 performs demodulation, channel decoding and so on of the downlink data output from the demapping section 403, based on the results of channel estimation in the channel estimation section 408. To be more specific, the PDSCH demodulating section 407 demodulates the PDSCH allocated to the subject user terminal based on the downlink control information demodulated in the PDCCH demodulating section 405, and acquires the downlink data (downlink user data and higher layer control information) for the subject user terminal.

The channel estimation section 408 performs channel estimation using demodulation downlink reference signals (DM-RSs), measurement reference signals (CRSs and CSI-RSs) and so on. The channel estimation section 408 outputs the result of channel estimation by the measurement reference signals (CRSs and CSI-RSs) to the PDCCH demodulating section 405. Meanwhile, the channel estimation section 408 outputs the result of channel estimation by the demodulation reference signals (DM-RSs) to the PDSCH demodulating section 407.

Up to this point, the present invention has been described in detail by way of the above-described embodiments. However, a person of ordinary skill in the art would understand that the present invention is not limited to the embodiments described in this description. The present invention could be embodied in various modified or altered forms without departing from the gist or scope of the present invention defined by the claims. Besides, the embodiments may be applied in combination appropriately. Therefore, the statement in this description has been made for the illustrative purpose only and not to impose any restriction to the present invention.

The disclosure of Japanese Patent Application No. 2013-025577 filed on Feb. 13, 2013, including the specification, drawings, and abstract, is incorporated herein by reference in its entirety.

1. A radio base station comprising:
an allocation control section that controls allocation to make an UL carrier for uplink transmission and a DL carrier for downlink transmission orthogonal to each other in a frequency direction; and
a transmission/reception section that performs transmission or reception of a signal by using either of the UL carrier and the DL carrier for a user terminal in one transmission time interval,
wherein the allocation control section controls a carrier adjacent to a carrier used by a different operator to have a same transmission direction as the carrier of the different carrier.

2. The radio base station according to claim 1, wherein the allocation control section allocates the DL carrier to be adjacent to a DL carrier of the different operator and allocates the UL carrier to be adjacent to a UL carrier of the different operator.

3. The radio base station according to claim 2, wherein the allocation control section allocates a carrier for device to device communication to between the DL carrier and the UL carrier.

4. The radio base station according to claim 1, wherein the allocation control section controls allocation by dynamically changing resource allocation rates in the frequency direction of the DL and UL carriers of a same operator.

5. The radio base station according to claim 1, wherein the allocation control section allocates a carrier with a predetermined gap provided between the carrier and the carrier of the different operator.

6. The radio base station according to claim 1, further comprising an information generating section that generates allocation information of the UL carrier and the DL carrier, and the transmission/reception section transmits the allocation information to the user terminal.

7. The radio base station according to claim 6, wherein the transmission/reception section notifies the user terminal of the allocation information by using RRC signaling at timing of RRC CONNECTION RECONFIGURATION.

8. The radio base station according to claim 7, wherein the transmission/reception section notifies the user terminal of an allocation position of PRACH, an allocation position of EPDCCH and an allocation position of a pilot signal by using the RRC signaling.

9. A user terminal communicating with a radio base station by using an UL carrier for uplink transmission and a DL carrier for downlink transmission that are orthogonal to each other in a frequency direction, the user terminal comprising:
a transmission/reception section that performs transmission or reception of a signal by using either of the UL carrier and the DL carrier in one transmission time interval; and
a determining section that determines a carrier to use for transmission or reception of the signal, based on allocation information of the UL carrier and the DL carrier notified from the radio base station,
wherein allocation of the UL carrier and the DL carrier is dynamically changed by the radio base station.

10. A radio communication method for a radio base station to communicate with a user terminal using an UL carrier for uplink transmission and a DL carrier for downlink transmission, the radio communication method comprising the steps of:
allocating, by the radio base station, the UL carrier and the DL carrier to be orthogonal to each other in a frequency direction; and
performing transmission or reception of a signal by using either of the UL carrier and the DL carrier for the user terminal in one transmission time interval,
wherein carrier allocation is performed to make a carrier that is adjacent to a carrier of a different operator have a same transmission direction as the carrier of the different carrier.

11. The radio base station according to claim 2, wherein the allocation control section controls allocation by dynamically changing resource allocation rates in the frequency direction of the DL and UL carriers of a same operator.

12. The radio base station according to claim 2, wherein the allocation control section allocates a carrier with a predetermined gap provided between the carrier and the carrier of the different operator.

13. The radio base station according to claim 2, further comprising an information generating section that generates allocation information of the UL carrier and the DL carrier, and the transmission/reception section transmits the allocation information to the user terminal.

14. The radio base station according to claim 3, wherein the allocation control section controls allocation by dynamically changing resource allocation rates in the frequency direction of the DL and UL carriers of a same operator.

15. The radio base station according to claim 3, wherein the allocation control section allocates a carrier with a predetermined gap provided between the carrier and the carrier of the different operator.

16. The radio base station according to claim 3, further comprising an information generating section that generates allocation information of the UL carrier and the DL carrier, and the transmission/reception section transmits the allocation information to the user terminal.
